(19) United States
(12) Patent Application Publication
(10) Pub. No.: US 2026/0332901 A1
(43) Pub. Date: Oct. 22, 2026

(54) CONTROL DEVICE, IMAGE CAPTURE APPARATUS, CONTROL METHOD, AND STORAGE MEDIUM

(71) Applicant: CANON KABUSHIKI KAISHA, Tokyo (JP)

(72) Inventor: SHINOBU WATANABE, Kanagawa (JP)

(21) Appl. No.: 19/529,403

(22) Filed: Feb. 4, 2026

(30) Foreign Application Priority Data
Feb. 12, 2025 (JP) 2025-020988

(51) Int. Cl. H04N 23/745; H04N 23/667; H04N 23/73; H04N 23/88; H04N 25/13; H04N 25/42; H04N 25/78

(52) U.S. Cl. CPC H04N 23/745; H04N 23/667; H04N 23/73; H04N 25/134; H04N 25/42; H04N 25/78; H04N 23/88

(57) ABSTRACT

A control device controls charge accumulation in photoelectric conversion elements of an image sensor capturing a subject blinking due to light sources of a plurality of colors. The device detects properties of the light sources based on image signals. The device obtains a first image captured during a first period longer than or equal to a blinking cycle of the subject and a group of second images captured during a shorter second period. The device detects a color tone using the first image and blinking properties using the group of second images. The device causes the photoelectric conversion elements corresponding to different colors to start charge accumulation at different timings based on the color tone and the blinking properties.

### BACKGROUND

### Field of the Technology

The present disclosure relates to a control device, an image capture apparatus, a control method, and a storage medium, and in particular relates to a technique for reducing the influence of flicker on an image sensor that performs a global shutter operation.

### Description of the Related Art

There is a technique for reducing variations in brightness between frames caused by flicker in moving image capturing, by specifying the blinking cycle of a light source and adjusting the exposure time of a global-shutter type image sensor (Japanese Patent Publication No. 2022-046310).

In recent years, a large number of lighting apparatuses have adopted R, G, and B light emitting diodes (LEDs), which can be operated as light sources of various colors. Incidentally, the blinking cycle of an LED differs for each color, and thus, when performing image capturing of a subject under such light sources, the tints of the subject confirmed by the user in a live view image may differ from the tints in an image recorded in accordance with an image capturing instruction given subsequently. In addition, for example, so-called surface flicker may occur, in which tints vary between images recorded during continuous image capturing. That is, under such light sources, images in which tints vary depending on an image capturing timing may be recorded.

### SUMMARY

The present technique has been invented in view of the aforementioned issues and provides a control device, an image capture apparatus, a control method, and a storage medium that realize image capturing in which variation in tints caused by blinking of light sources is reduced.

The present technology, in one aspect, provides a control device for controlling an operation of an image sensor, comprising: a control unit for controlling charge accumulation in a plurality of photoelectric conversion elements of the image sensor that captures an image of a subject illuminated by light sources of a plurality of colors, each light source blinking at a respective blinking frequency; and a detection unit for detecting properties of the light sources of the respective colors based on image signals output from the image sensor, wherein the detection unit is configured to: obtain a first image captured during a first period that is longer than or equal to one cycle of blinking of the subject and a second image group of a plurality of second images captured during a second period that is shorter than the first period; detect color tone of the subject blinking due to the light sources of the plurality of colors, using the first image; and detect blinking properties of the light sources of the respective colors using the second image group, and the control unit is configured to cause the photoelectric conversion elements of the image sensor that correspond to different colors to start charge accumulation at different timings based on the detected color tone and the detected blinking properties of the light sources of the respective colors.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration of an image capture apparatus 100 according to embodiments and variations of the present technique.

FIG. 2 is a schematic diagram illustrating a configuration of a light-receiving surface of an image sensor 2 according to the embodiments and variations of the present technique.

FIG. 3 is a schematic diagram illustrating a configuration of a non-light-receiving surface of a PD substrate 20 of the image sensor 2 according to the embodiments and variations of the present technique.

FIG. 4 is a schematic diagram illustrating a configuration of a stacked substrate 21 of the image sensor 2 according to embodiments and variation of the present technique.

FIG. 5 is an equivalent circuit diagram illustrating a configuration of a PD 10, a pixel circuit 11, and a stacked circuit 12 according to a first embodiment of the present technique.

FIG. 6 is a timing chart illustrating operation control of the image sensor 2 in a case of performing a global shutter operation according to the embodiments and variations of the present technique.

FIG. 7 is a timing chart illustrating drive control of an equivalent circuit according to the first embodiment of the present technique.

FIG. 8 is a diagram for describing a first operation mode according to the embodiments and variations of the present technique.

FIG. 9 is a diagram for describing a second operation mode according to the first embodiment of the present technique.

FIG. 10 is a timing chart illustrating operation control for the second operation mode according to the first embodiment of the present technique.

FIG. 11 is a flowchart illustrating still image capturing processing that is executed by the image capture apparatus 100 according to the first embodiment of the present technique.

FIG. 12 is an equivalent circuit diagram illustrating a configuration of a PD 10, a pixel circuit 11, and a stacked circuit 12 according to a second embodiment of the present technique.

FIG. 13 is a timing chart illustrating operation control for a third operation mode according to the second embodiment of the present technique.

FIG. 14 is a timing chart illustrating drive control of an equivalent circuit in the third operation mode according to the second embodiment of the present technique.

### DESCRIPTION OF THE EMBODIMENTS

### First Embodiment

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In an embodiment to be described below, an example will be described in which the present technique is applied to an image capture apparatus including an image sensor configured to be capable of performing a global shutter operation, as an example of an image capture apparatus. Examples of such an image capture apparatus may include digital still cameras, digital video cameras, vehicle-mounted cameras, surveillance cameras, smartphones. However, the present technique is applicable to any device (control device) capable of controlling an image capturing operation using an image sensor configured to be capable of performing a global shutter operation.

### Configuration of Image Capture Apparatus

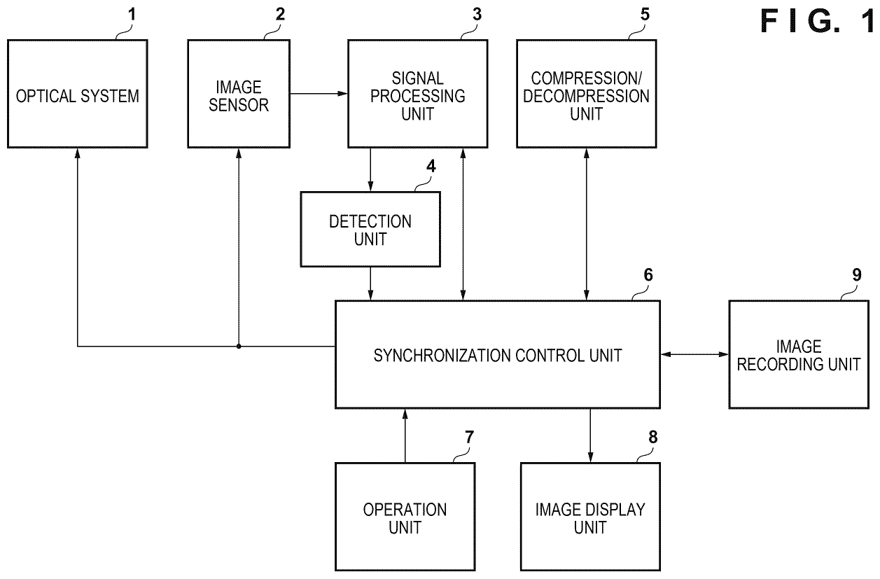

FIG. 1 is a block diagram illustrating a configuration of an image capture apparatus 100 according to the present embodiment. The blocks shown in FIG. 1 may have a software configuration that is realized by a control device (not illustrated) executing a specific program, or may have a hardware configuration that is realized by specific hardware components. Alternatively, each block may be realized by a combination of these. When a block is realized as a hardware configuration, a dedicated circuit (ASIC), a processor (reconfigurable processor, DSP), and the like can be used. In addition, blocks realized as hardware configurations do not need to be incorporated into the same housing, and may be configured by a plurality of devices communicably connected to each other via, for example, a signal path.

An optical system 1 includes a lens, a lens driving mechanism, a mechanical shutter mechanism, an aperture mechanism, and the like. In a drive system included in the optical system 1, drive control is performed based on a control signal supplied from a synchronization control unit 6 to be described later.

An image sensor 2 is a complementary metal oxide semiconductor (CMOS) image sensor to which a Bayer array filter is applied, and which employs an XY addressing method. Control related to an image capturing operation of the image sensor 2 is performed based on a control signal supplied from the synchronization control unit 6. The image sensor 2 photoelectrically converts an optical image formed on an image capturing surface via the optical system 1, and further outputs signals digitized by an A/D conversion circuit included in the image sensor 2, to a signal processing unit 3 as image signals.

The signal processing unit 3 performs various types of image processing such as noise correction and white balance processing, on the image signals input from the image sensor 2. In addition, the signal processing unit 3 also executes processing related to generation of control information, such as auto focus (AF) and auto exposure (AE) based on the image signals. Besides, the signal processing unit 3 also executes computation processing for detecting blinking of light sources, which will be described in detail later. The various types of processing are executed by the signal processing unit 3 based on a control signal supplied from the synchronization control unit 6. In addition, the image signals after image processing and the control information, generated by the signal processing unit 3, are output to the synchronization control unit 6 and are used to control the blocks.

A detection unit 4 obtains a result of computation for blinking detection performed by the signal processing unit 3, and detects properties related to blinking of light sources in an image capturing environment based on the computation result. By performing this detection processing, the detection unit 4 can output information such as blinking cycles and phases of the light sources as detection result information, and the synchronization control unit 6 controls a readout operation of the image sensor 2 based on the detection result information.

A compression/decompression unit 5 performs compression/encoding processing on image signals after image processing performed by the signal processing unit 3, and decompression/decoding processing on encoded data of still images. The compression/decompression unit 5 may also perform compression/encoding processing and decompression/decoding processing on moving images. Operation control of the compression/decompression unit 5 is performed based on a control signal supplied from the synchronization control unit 6.

The synchronization control unit 6 controls the operations of the blocks of the image capture apparatus 100. The synchronization control unit 6 can employ, for example, a microcontroller constituted by a central processing unit (CPU), a read-only memory (ROM), a random-access memory (RAM), etc. In this aspect, the synchronization control unit 6 can collectively control the operations of the blocks by deploying a program stored in the ROM to the RAM and executing the program.

An operation unit 7 has various operation members (user interfaces) such as a shutter release button. Upon detecting operation input performed on the various user interfaces, the operation unit 7 outputs a control signal corresponding to the operation input to the synchronization control unit 6. Examples of operation input that can be detected by the operation unit 7 may include settings for a recording mode for a still image, a moving image, etc., exposure control (an aperture, a shutter speed, ISO sensitivity), and input related to an image capturing instruction, etc.

An image display unit 8 controls image display on a display device (not illustrated), such as a liquid crystal display (LCD). The image display unit 8 outputs image signals to be displayed to the display device, such that the image signals are displayed.

An image recording unit 9 records a compressed and encoded image data file generated by the compression/decompression unit 5, in a recording device (not illustrated) connected to the image capture apparatus 100. Such a recording device may include, for example, a recording device incorporated into the image capture apparatus 100, such as an HDD or memory, and a removable recording device such as a memory card.

### Circuit Configuration of Image Sensor

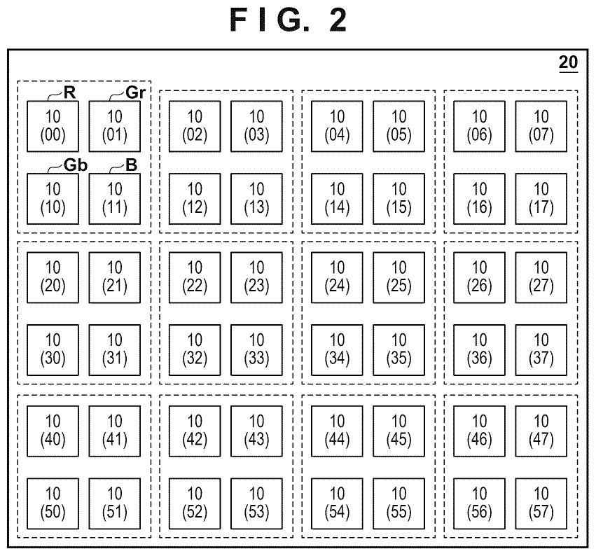

Next, a circuit configuration of the image sensor 2 will be described with reference to FIGS. 2 to 4.

The light-receiving surface (image capturing surface) of the image sensor 2 is configured as shown in the schematic diagram in FIG. 2. On the light-receiving surface of the image sensor 2, photodiodes (PDs (photoelectric conversion elements)) 10 that perform photoelectric conversion of incident light to generate electric charges are two-dimensionally arranged on a PD substrate 20. In one aspect, the PD substrate 20 may be an N-type silicon substrate, and the PDs 10 may be N-type semiconductor regions. The PDs 10 are configured to store electrons out of electron-hole pairs that are generated when light is received.

Drive timings will be described in detail after the explanation of an equivalent circuit diagram that includes the pixel circuit 11.

In the illustrated example, to facilitate understanding of the present technique, the PDs 10 are arranged in six rows and eight columns, but tens of millions of PDs 10 or more may be arranged in the image sensor 2. In FIG. 2, a specific PD 10 disposed in the p^{th} row and the q^{th} column is represented by a set of numbers in parentheses, such as “PD 10 (pq)”.

The image capture apparatus 100 according to the present embodiment is configured to be capable of capturing color images, and thus a Bayer array color filter is applied to the PDs 10 of the image sensor 2. The color filter is applied in units of PDs 10 in 2 rows×2 columns arranged in rectangular regions indicated by the broken lines in FIG. 2. In the illustrated example, an R filter is applied to the PD 10 disposed in the upper left of each rectangular region, a Gr filter is applied to the PD 10 disposed in the upper right, a Gb filter is applied to the PD 10 disposed in the lower left, and a B filter is applied to the PD 10 disposed in the lower right.

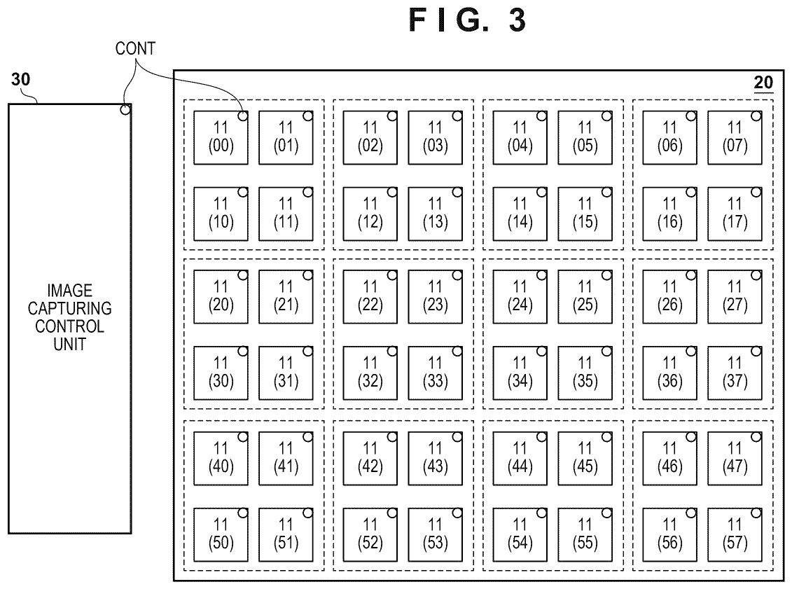

FIG. 3 shows a schematic diagram of the non-light-receiving surface of the PD substrate 20 of the image sensor 2, as viewed from the light-receiving surface side (viewed from the direction of light incidence). The pixel circuits 11 are two-dimensionally arranged on the non-light-receiving surface so as to be associated with the respective PDs 10. The parenthesized sets of numbers assigned to the pixel circuits 11 in FIG. 3 correspond to those assigned to the PDs 10 in FIG. 2 respectively connected to the pixel circuits 11. That is to say, the pixel circuit 11 (pq) disposed on the non-light-receiving surface of the PD substrate 20 corresponds to the PD 10 (pq) disposed in the p^{th} row and q^{th} column on the light-receiving surface of the PD substrate 20, and is connected to that PD 10 (pq).

Hereinafter, a PD 10 and a pixel circuit 11 connected to each other may be simply referred to as a “pixel”. That is to say, the PD 10 (pq) and the pixel circuit 11 (pq) constitute one pixel. In addition, a pixel to which an R filter is applied may be referred to as an “R pixel”, a pixel to which a Gr filter is applied may be referred to as a “Gr pixel”, a pixel to which a Gb filter is applied may be referred to as a “Gb pixel”, and a pixel to which a B filter is applied may be referred to as a “B pixel”.

Each pixel circuit 11 is connected to a stacked circuit 12 of a later-described stacked substrate 21 via a contact CONT, and can thereby transfer a voltage signal VI, which is an output, to the stacked circuit 12. Note that the contact CONT is also used when a control signal from an image capturing control unit 30 is transmitted to the PD 10 or the like.

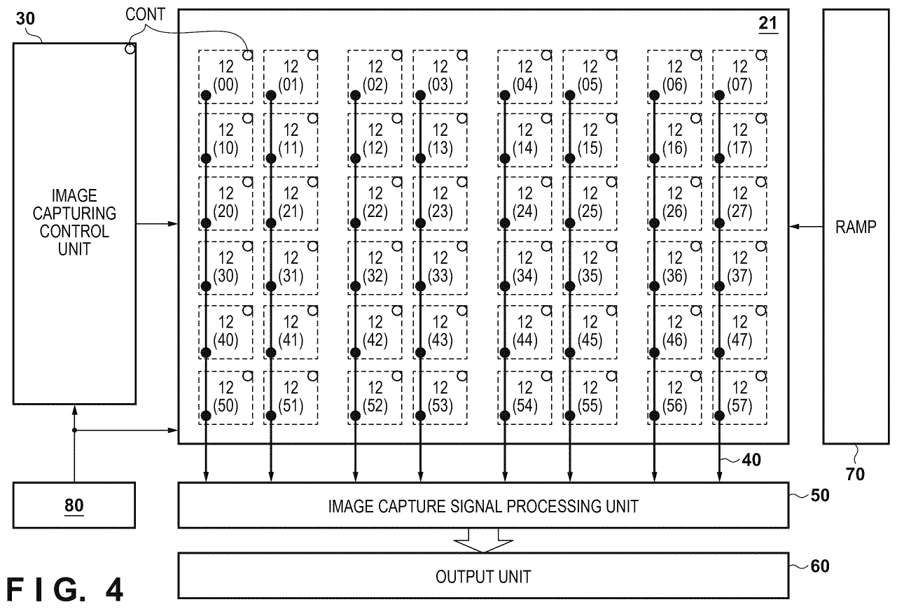

Next, FIG. 4 shows a schematic diagram of the stacked substrate 21 of the image sensor 2. The stacked circuits 12 are two-dimensionally arranged on the stacked substrate 21 so as to be associated with the respective pixel circuits 11. The parenthesized sets of numbers assigned to the stacked circuits 12 in FIG. 4 correspond to those assigned to the pixel circuits 11 in FIG. 3 respectively connected to the stacked circuits 12. In other words, the stacked circuit 12 (pq) disposed on the stacked substrate 21 corresponds to the pixel circuit 11 (pq) disposed in the p^{th} row and q^{th} column of the non-light-receiving surface of the PD substrate 20, and is connected to the pixel circuit 11 (pq) via the contact CONT. That is, the voltage signal VI that is output from the pixel circuit 11 (pq) is transferred to the corresponding stacked circuit 12 (pq) via the contact CONT.

Each stacked circuit 12 is provided with an A/D conversion circuit corresponding to the pixel. For A/D conversion, a reference signal VRamp, which changes in proportion to time, is input to the A/D conversion circuit from RAMP 70 that is a ramp voltage generation circuit. The voltage signal VI transferred from the pixel circuit 11 is converted into a digital signal in the A/D conversion circuit and is held in a memory (not illustrated) within the stacked circuit 12.

A data transfer unit 40 transfers the digital signal obtained through A/D conversion to an image capture signal processing unit 50.

The image capture signal processing unit 50 performs various types of signal processing including correlated double sampling (CDS) processing, offset processing, and gain correction processing, on a digital signal that has been input thereto.

An output unit 60 outputs a digital signal to which signal processing has been applied by the image capture signal processing unit 50, to the outside of the image sensor 2.

A timing generation circuit 80 generates a pulse signal for controlling A/D conversion processing and the like performed in the image capturing control unit 30, the image capture signal processing unit 50, and the stacked circuit 12, and supplies the generated pulse signal to a corresponding block.

### A/D Conversion of Image Signals

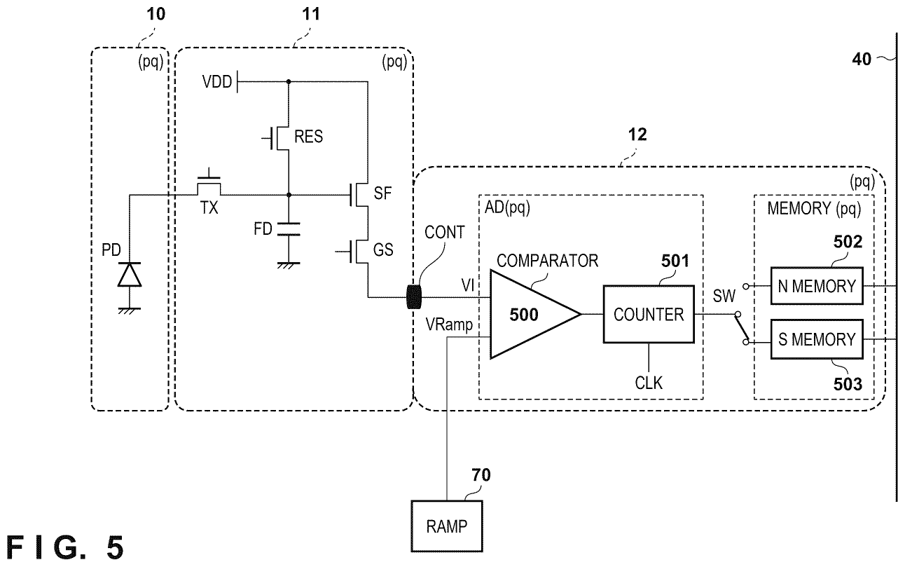

Next, a flow of A/D conversion of image signals related to image capturing using the image sensor 2 having the above configuration will be described in detail with reference to FIG. 5. FIG. 5 shows an equivalent circuit diagram of the PD 10 (pq), the pixel circuit 11 (pq), and the stacked circuit 12 (pq), which are involved in A/D conversion related to the PD 10 (pq).

As illustrated in the figure, on the PD substrate 20, the pixel circuit 11 (pq) includes, in addition to the PD 10 (pq) that is a photoelectric conversion unit, a transfer transistor TX for transferring charges generated in the PD 10 (pq) to a charge-voltage conversion node (floating diffusion (FD) node). The pixel circuit 11 (pq) is also provided with a reset transistor (RES) that can reset the FD node using a predetermined power source VDD. The pixel circuit 11 (pq) is also provided with an amplification transistor (SF) whose gate is connected to the FD node and that forms a source follower circuit using a current source (not illustrated), and a global-shutter transfer transistor (GS) whose drain is connected to the source of SF.

Among the transistors provided in the pixel circuit 11 (pq), the gates of RES, TX, and GS are configured to be controllable by the image capturing control unit 30 for each color (R color, G color (Gr and Gb), and B color). Therefore, the image sensor 2 according to the present embodiment is configured such that a reset operation of the PD 10, charge transfer from the PD 10 to the FD, and readout of the voltage signal VI corresponding to the amount of charges accumulated in FD to the stacked circuit 12 (pq) can be collectively controlled for each color.

As described above, the A/D conversion circuit (A/D conversion node: AD (pq)) and the memory (pq) are provided in the stacked circuit 12 (pq). The image sensor 2 according to the present embodiment employs a single-slope A/D conversion circuit, and a comparator 500 and a counter 501 are provided in AD (pq). Therefore, the source of GS is connected to one input terminal of the comparator 500 via the contact CONT.

The comparator 500 is configured to be capable of receiving two types of signals and to output Lo or Hi in accordance with the magnitude of a received signal. The other input terminal of the comparator 500 receives the reference signal VRamp from the RAMP 70, and the comparator 500 compares the magnitudes of the voltage signal VI and the reference signal VRamp with each other. In the present embodiment, the comparator 500 is configured to output Hi when the reference signal VRamp exceeds the voltage signal VI, and to output Lo when the reference signal VRamp does not exceed the voltage signal VI.

A clock signal (CLK) generated by the timing generation circuit 80 is input to the counter 501 provided downstream of the comparator 500. The level of the reference signal VRamp sequentially decreases due to a slope voltage generation circuit (not illustrated), and the counter 501 counts CLK during a period from when the level of the reference signal VRamp started to decrease until when output of the comparator 500 becomes Lo. In other words, CLK is input to the counter 501 when the level of the reference signal VRamp starts to decrease, and the counter 501 counts (up) CLK during a period when the output of the comparator 500 is Hi. With such a configuration, A/D conversion is performed in which the voltage signal VI input to the comparator 500 is converted into a digital signal.

Here, in order to output a digital signal corresponding to the amount of charges accumulated in the PD 10 (pq) based on incident light, that is, a digital signal corresponding to the amount of light of a subject image received by the PD 10 (pq), the memory (pq) is provided with an N memory 502 and an S memory 503. SW is configured to be switchable between a state of being connected to either the N memory 502 or the S memory 503 or a state of being connected to neither of them.

The N memory 502 stores a digital signal obtained by A/D converting a voltage signal VI (hereinafter may be referred to as an “N signal”) of the FD node in a state where the FD node is reset, i.e., where charges generated in the PD 10 (pq) have not been transferred nor accumulated. That is to say, an N signal indicates the reset level of the FD node.

On the other hand, the S memory 503 stores a digital signal obtained by A/D converting a voltage signal VI (hereinafter may be referred to as an “S signal”) of the FD node in a state where charges generated in the PD 10 (pq) have been transferred and stored. That is to say, an S signal indicates the level of a voltage corresponding to the amount of charges generated in the PD 10 (pq), in a state of being superimposed on an N signal.

Therefore, the image capture signal processing unit 50 obtains a digital signal related to the N signal held in the N memory 502 and a digital signal related to the S signal held in the S memory 503, via the data transfer unit 40. The image capture signal processing unit 50 then performs CDS processing to subtract the digital signal related to the N signal from the digital signal related to the S signal. With such a configuration, the image capture signal processing unit 50 can derive a digital signal corresponding to the amount of light of a subject image received by the PD 10 (pq).

### Overview of Operation Control of Image Sensor

### Global Shutter Operation

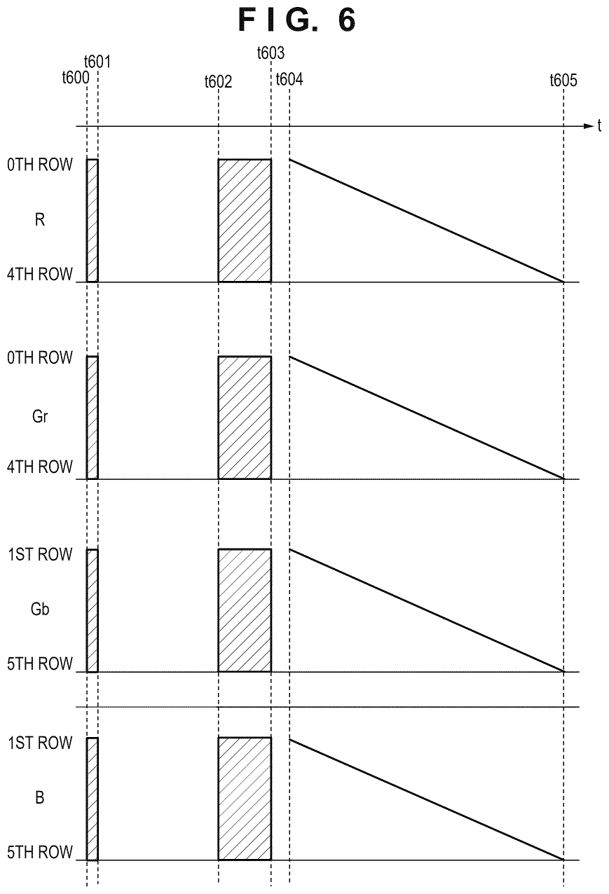

When the image sensor 2 having the above circuit configuration performs a global shutter operation, elements involved in charge accumulation, charge transfer, A/D conversion, and readout of a digital signal are controlled as follows. FIG. 6 shows a timing chart related to operation control of elements related to pixels of the colors in the image sensor 2 when performing a global shutter operation.

Here, in the example shown in FIG. 2, in the image sensor 2, six rows and eight columns of pixels are provided, and a Bayer array filter is applied. For this reason, the vertical axes of the timing chart in FIG. 6 represents the 0th to 4th rows to which R pixels and Gr pixels are distributed, and the 1st to 5th rows to which Gb pixels and B pixels are distributed. In the timing chart in FIG. 6, hatched rectangular regions each indicate that a corresponding operation is performed collectively for all the rows in which the pixels of the color are distributed during the indicated period. For example, the hatched rectangular region shown for R pixels during the period from time t600 to t601 indicates that the same operation is performed simultaneously during that period for all the R pixels distributed in the 0th, 2nd, and 4th rows. In addition, in the timing chart, a straight line that is not accompanied by a hatched region indicates that a corresponding operation is performed while a row in which the pixels of the color are distributed is switched sequentially during the period. For example, the straight line shown for R pixels during the period from time t604 to t605 indicates that the row for which the operation can be performed is switched sequentially in the order of the R pixels distributed in the 0th row, the R pixels distributed in the 2nd row, and the R pixels distributed in the 4th row.

In the global shutter operation, for all of the pixels of the image sensor 2, the operations of the processes of charge accumulation, charge transfer, A/D conversion, and readout of digital signals are collectively controlled. For this reason, although the elements related to the pixels of each color are distributed in different rows, control is performed so as to collectively perform the same processing during the periods from time t600 to t601, from time t602 to t603, and from time t604 to t605.

The period from time t600 to t601 corresponds to an exposure period (charge accumulation process), and the PDs 10 of the pixels perform photoelectric conversion of incident light and perform charge accumulation during the same exposure period. For this reason, prior to t600, the PDs 10 and the FD nodes are reset. As a result, the PDs 10 and the FD nodes are reset collectively for all pixels of the image sensor 2.

The period from time t602 to t603 is a period during which various digital signals are stored in the memory, and which corresponds to the processes of charge transfer and A/D conversion. That is, during this period, a digital signal obtained by A/D converting an N signal that is generated when the FD node of each pixel is released from reset is stored in the N memory 502. Next, the charges accumulated in the PD 10 of each pixel are transferred to the FD node of that pixel, and a digital signal obtained by A/D converting an S signal that is generated in the FD node where the charges are accumulated is stored in the S memory 503. As a result, for all pixels of the image sensor 2, digital signals related to the N and S signals are stored in the memory.

The period from time t604 to t605 corresponds to the process of readout of digital signals. During this period, while sequentially switching the 0th row (in which R pixels and Gr pixels are distributed) to 5th row (Gb pixels and B pixels) of the image sensor 2, the data transfer unit 40 reads out the digital signals for the N and S signals stored in the memories of the pixels of each row, and transfers the digital signals to the image capture signal processing unit 50. The image capture signal processing unit 50 performs CDS processing on the transferred digital signals to derive digital signals (hereinafter may be referred to as “image capture signals”) corresponding to a subject image formed on the corresponding pixels.

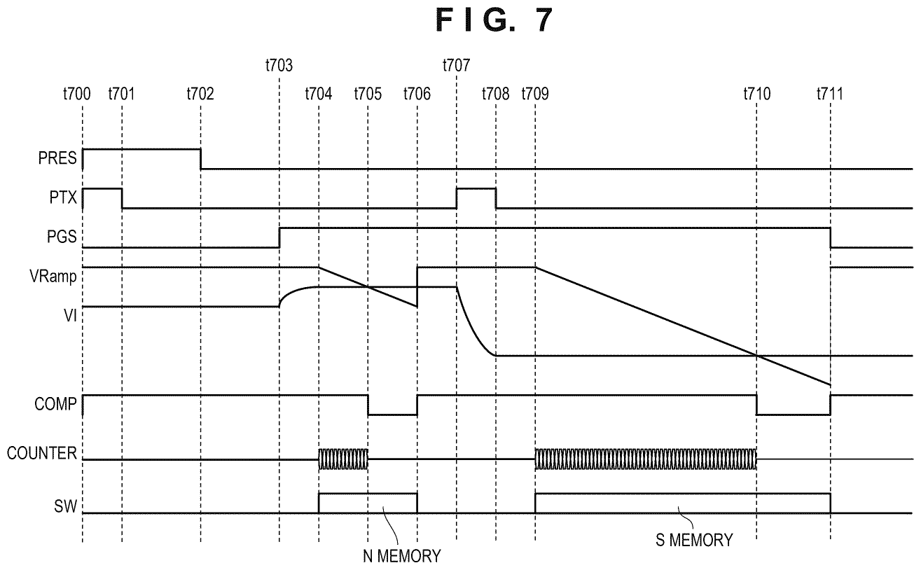

FIG. 7 shows a timing chart of drive control of the equivalent circuit (FIG. 4) related to one pixel when the above global shutter operation is performed. In the figure, PRES, PTX, and PGS respectively denote control signals supplied to RES, TX, and GS, and each indicate the polarity of a voltage applied to the gate of the transistor. That is, drive control is performed such that, when a control signal is Hi, the corresponding transistor is switched ON, and, when a control signal is Lo, the corresponding transistor is switched OFF. These control signals may be generated by the timing generation circuit 80.

In addition, in the figure, the reference signal VRamp and the voltage signal VI indicate temporal changes in the levels of the signals input to the comparator 500. COMP indicates output of the comparator 500, and is Hi during the period in which the reference signal VRamp exceeds the voltage signal VI, and is Lo during the period in which the reference signal VRamp does not exceed the voltage signal VI, as described above.

In addition, in the figure, the counter schematically indicates the count (count up) of the counter 501. Also in the figure, SW indicates the connection state of SW provided between the counter 501 and the memory, indicating that SW is not connected to any memory during a Lo period and whether SW is connected to the N memory 502 or the S memory 503 during a Hi period.

At time t700, PRES and PTX rise to Hi, and the PD 10 and the FD node are reset.

At time t701, when PTX is changed to Lo, the reset state of the PD 10 is released, and charge accumulation starts in the image capture apparatus 100. That is to say, time t701 corresponds to time t600 in the timing chart in FIG. 6.

At time t702, when PRES is changed to Lo, the reset state of the FD node is released. Thereafter, at time t703, when PGS is changed to Hi, the voltage signal VI indicating the reset level of the FD node, i.e., the N signal is input to the comparator 500 via the contact CONT.

At time t704, the reference signal VRamp is input to the comparator 500. The level of the reference signal VRamp is sequentially decreased over time from an initial (voltage) value from time t704 due to a slope voltage generation circuit. Also, at time t704, when the level of the reference signal VRamp starts to decrease, CLK is supplied to the counter 501, and the counter 501 starts counting. Also at time t704, SW is connected to the N memory 502.

When the reference signal VRamp input to the comparator 500 falls to or below the voltage signal VI (N signal), time t705 is reached. At this time, output of the comparator 500, which is denoted by COMP, becomes Lo. In addition, the counter 501 stops counting when COMP becomes Lo. Accordingly, the count value of the counter 501 indicates a value obtained by A/D converting the N signal. This value is stored in the N memory 502 as a digital signal related to the N signal. Thereafter, at time t706, the slope voltage generation circuit stops decreasing the level of the reference signal VRamp and returns the level to the initial voltage, and thus the reference signal VRamp exceeds the voltage signal VI again. Accordingly, the output COMP of the comparator 500 rises to Hi. In addition, SW is changed from a state of being connected to the N memory 502 to a state of being not connected to any memory.

At time t707, when PTX is changed to Hi, transfer of the charges accumulated in the PD 10 to the FD node is started, and the charges are accumulated in the FD node. Thereafter, at time t708, when PTX falls to Lo, the voltage signal VI corresponding to the amount of charges of the FD node, namely an S signal is input to the comparator 500 via the contact CONT.

The level of the reference signal VRamp is sequentially decreased over time from an initial value from time t709 due to the slope voltage generation circuit. Also, at time t709, the level of the reference signal VRamp starts to decrease, and CLK is supplied to the counter 501 such that the counter 501 starts counting. Also at time t709, SW is connected to the S memory 503.

When the reference signal VRamp input to the comparator 500 falls to or below the voltage signal VI (S signal), time t710 is reached. At this time, the output COMP of the comparator 500 becomes Lo. In addition, the counter 501 stops counting in accordance with COMP becoming Lo. Accordingly, the count value of the counter 501 indicates the value obtained by A/D converting the S signal. This value is stored in the S memory 503 as a digital signal related to the S signal. Thereafter, at time t711, the slope voltage generation circuit stops decreasing the level of the reference signal VRamp, and thus the reference signal VRamp exceeds the voltage signal VI again. Accordingly, the output COMP of the comparator 500 becomes Hi. In addition, SW is changed from a state of being connected to the S memory 503 to a state of being not connected to any memory. In addition, the A/D conversion process is ended due to the operations performed until time t711, and thus PGS is changed to Lo. That is to say, time t711 corresponds to time t603 in the timing chart in FIG. 6.

By the image sensor 2 performing the global shutter operation in this manner, it is possible to obtain image capture signals obtained through exposure of the PDs 10 for all the pixels during the same period.

### Change in Color Tone Due to Difference in Blinking Cycle of LEDs

Incidentally, the blinking cycle of an LED is different for each color. The blinking cycle refers to the manner in which the LED turns on and off or increases and decreases in intensity over time (i.e. due to characteristics of the driving circuit such the frequency of an AC power supply). The frequency at which the LED turns on and off is referred to as the blinking frequency, where an LED with a shorter blinking cycle will have a higher blinking frequency. Accordingly, when a light source includes LEDs of a plurality of colors as described above, an amount of received light may differ in accordance with the shift (phase difference) between blinking cycles, depending on the length of an exposure time. That is, if an exposure time is set to be sufficiently long relative to the blinking cycles of the respective colors of the LEDs included in the light source, the difference in the number of blinks between the colors of the LEDs during this time becomes relatively small (relative to the total number of blinks). For this reason, the image capture signals of the pixels for the colors are less likely to exhibit an intensity difference corresponding to the difference in the number of blinks during the exposure period. On the other hand, if an exposure time is not set to be sufficiently long relative to the blinking cycles of the respective colors of LEDs, the difference in the number of blinks between the colors of the LEDs during this time becomes relatively large. For this reason, the image capture signals of the pixels for the colors are more likely to exhibit an intensity difference corresponding to the difference in the number of blinks during the exposure period. In particular, this applies to cases where a subject is captured using, as a light source, an LED that blinks at a cycle faster than a shutter speed that is set for capturing an image of the subject.

For example, consider an aspect in which the image capture apparatus 100 that performs live view display at 60 fps uses, as a live view image, image capture signals obtained through exposure for a time sufficiently long relative to the blinking cycles of the respective colors of the LEDs during its frame period (16.6 ms). At this time, the intensity difference corresponding to the difference in the number of blinks between the colors of the LEDs is negligible, and thus a live view image obtained by developing the image capture signals shows color tone close to (high reproducibility) the color tone of the subject. On the other hand, for example, if the exposure time for image capturing set by the user is not sufficiently long relative to the blinking cycles of the colors of the LEDs, an image to be recorded (hereinafter referred to as a recorded image) will be affected by the intensity difference corresponding to the difference in the number of blinks between the colors of the LEDs. That is to say, the image capture signals obtained through exposure for the exposure time may exhibit an intensity difference between the colors due to a difference in the number of blinks of the LEDs, and thus a recorded image obtained by developing the image capture signals may be an image showing color tone different from the color tone of the subject. Therefore, even if the user confirms and captures live view display, a recorded image may have color tone different from the color tone displayed in the live view image at the time of the confirmation. In addition, when performing continuous image capturing or moving image capturing, color tone varies between a plurality of recorded images (or frame images) that are obtained, in correspondence with the difference in exposure timing, making it impossible to obtain uniform recorded images.

For this reason, the image capture apparatus 100 of the present embodiment has two modes for performing operation control of the image sensor 2: a first operation mode for detecting the blinking properties for the respective colors of the light source, and a second operation mode for realizing image capturing in which color tone variations caused by difference in the blinking properties between the colors are reduced. The first operation mode may be set by the synchronization control unit 6, for example, when the image capture apparatus 100 is activated in an image capture mode or when a half-press input of the shutter release button (operation input related to an image capturing preparation instruction) is detected. In addition, the second operation mode may be set by the synchronization control unit 6, for example, when full-press input of the shutter release button (operation input related to an image capturing instruction) is detected. The operation modes will be described below in detail. Note that, in the following description, an LED that emits light of R components included in the light source may be referred to as LED_R, an LED that emits light of G components as LED_G, and an LED that emits light of B components as LED_B.

### First Operation Mode

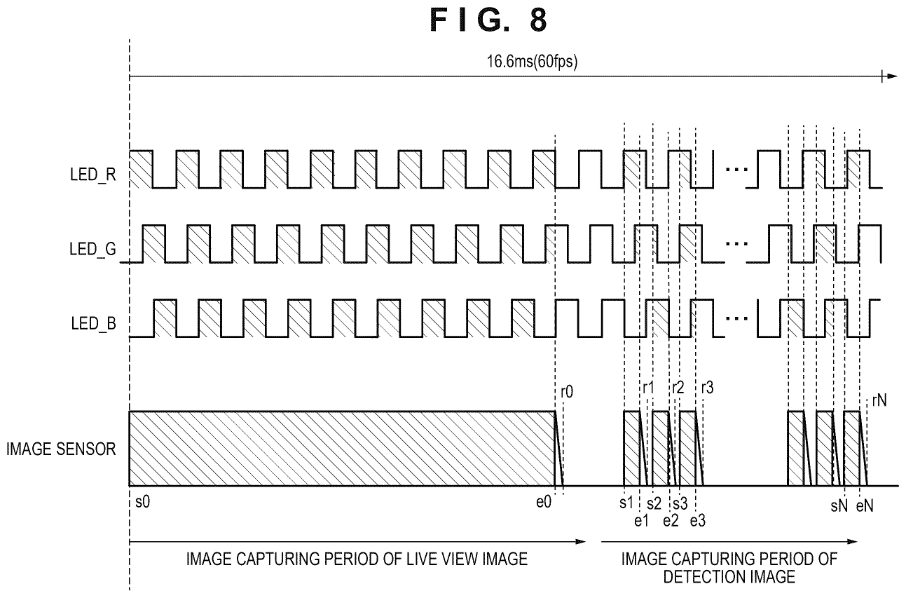

In the first operation mode, as shown in FIG. 8, within one frame period of live view display, an image for live view display (live view image) and images for blinking detection (detection images) for each color are both captured by performing the global shutter operation.

The step waveforms in the upper part of FIG. 8 schematically indicate blinking of the light sources LED_R, LED_G, and LED_B. In addition, the lower part schematically shows a timing chart for operation control of pixel rows of the image sensor 2 with respect to processes of charge accumulation to readout of digital signals performed for capturing each image. In the timing chart in the lower part, sn, en, and rn (n is an integer of 0 or greater) indicate the start of charge accumulation in the PD 10, the end of A/D conversion, and the end of readout of the image capture signals after CDS processing, respectively. The separate time segments illustrated as hatched portions in the upper part represent time periods during which light is emitted from the LEDs, the light to be photoelectrically converted in image capturing performed during the corresponding time periods in the lower part.

Since it is sufficient for a single live view image to be obtained for one frame period of live view display, live view image capturing is performed once during the period. In addition, since it is preferable that a live view image shows color tone close to that of the subject and the color tone is stable between frames, an exposure time that is sufficiently long relative to the blinking cycles of the LEDs is set. In the example in FIG. 8, in one frame period (16.6 ms) related to live view display at 60 fps, 8.0 ms that corresponds to Tv= 1/125 is set as an exposure time for live view image capturing. In the figure, the exposure time related to live view image capturing includes approximately 10 cycles of blinking of an LED for each color.

On the other hand, as illustrated in the figure, LED_R, LED_G, and LED_B blink at different frequencies, resulting in a phase difference in the changes in the signal intensity between R pixels, Gr pixels, Gb pixels, and B pixels. In order to derive such phase difference in blinking of the LEDs of the respective colors, it is necessary to obtain, as a detection image, an image in which color tone variations intentionally appear, rather than an image showing high color reproducibility of the subject as in a live view image. In addition, the color tone in a detection image differs depending on an image capturing timing, that is to say, the blinking state of the LEDs of the respective colors differs at an image capturing timing, and thus detection images are captured a plurality of times during one frame period.

In the example in FIG. 8, a time shorter than the blinking cycles of the LEDs is set as an exposure time for capturing a detection image such that a detection image is captured N times using a common exposure period during a period after one live view image has been captured during one frame period. In the N detection images obtained by performing image capturing N times, the R pixels, Gr pixels, Gb pixels, and B pixels indicate pixel values corresponding to different blinking states. Here, the exposure time for capturing detection images may be, for example, an exposure time value that is an image capturing parameter set by the user, or may be a predetermined value. The exposure time is set to a time sufficiently short relative to the blinking cycles of the LEDs that are the light sources.

Based on the N detection images obtained in this manner, the signal processing unit 3 determines which light source (LED_R, LED_G, or LED_B) is emitted for each of the detection images. This determination is performed by applying predetermined computation processing to the R pixels, the G pixels (Gr and Gb pixels), and the B pixels. The signal processing unit 3 then transmits, to the detection unit 4, the determination results, that is, discrete computation results indicating variations in image signals for the colors with respect to the image capturing performed N times.

The detection unit 4 derives a blinking cycle (or frequency) and a phase as blinking properties of each of LED_R, LED_G, and LED_B based on the determination results input from the signal processing unit 3. This derivation can be performed through frequency analysis using discrete Fourier transform, for example, on the discrete image signals, which are determination results. In addition, as will be described in detail later, in the second operation mode, the image sensor 2 of the present embodiment generates a recorded image using digital signals obtained at different exposure timings for each color such that the blinking phases are aligned. In the present embodiment, the adjustment of exposure timings such that the blinking phases are aligned is performed based on blinking of LED_R, and thus the detection unit 4 also derives a phase difference T_g between blinking of LED_R and blinking of LED_G and a phase difference T_b between blinking of LED_R and blinking of LED_B. Information regarding the blinking properties of the light source derived by the detection unit 4 is transmitted to the synchronization control unit 6.

### Second Operation Mode

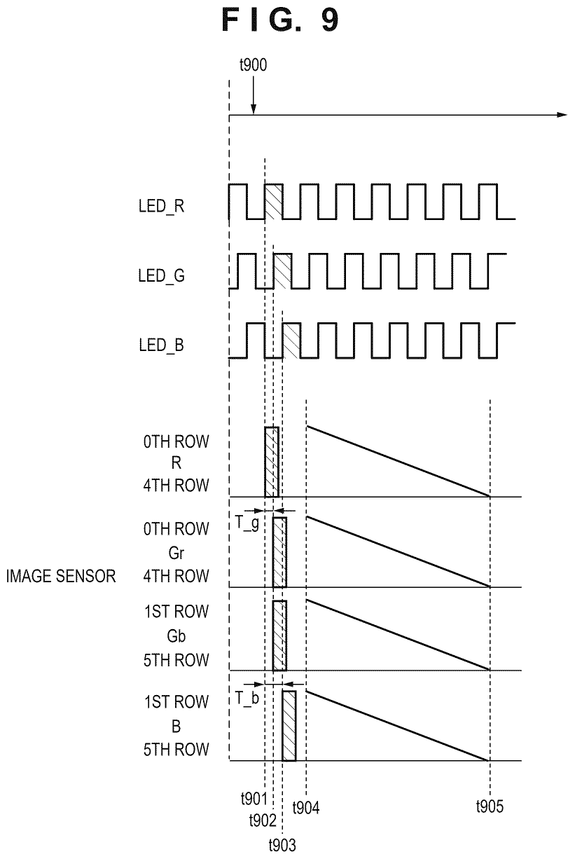

In the second operation mode, as shown in FIG. 9, when operation input related to an image capturing instruction is performed, image capturing that involves charge accumulation for an exposure time set as an image capturing parameter is performed. In the second operation mode, drive control of the image sensor 2 is performed so as to collectively expose pixels for each color, rather than the global shutter operation of collectively exposing all of the pixels.

Similarly to FIG. 8, the upper part of FIG. 9 schematically shows step waveforms related to blinking of the LEDs for the respective colors, and the lower part schematically shows a timing chart related to operation control of pixel rows of the image sensor 2. Unlike FIG. 8, in the second operation mode, the processes of charge accumulation to readout of digital signals are performed for each color, and therefore the lower part of FIG. 9 shows the operations of R pixels, Gr pixels, Gb pixels, and B pixels individually.

When operation input related to an instruction to capture a still image is detected at time t900, charge accumulation in the R pixels of the image sensor 2 is started first collectively at time t901. This charge accumulation is performed during an entire exposure time that is an image capturing parameter. In the present embodiment, charge accumulation in the R pixels is started at the timing when LED_R after operation input related to an image capturing instruction has been detected changes from an off state to an on state, based on information regarding the blinking properties of LED_R. In addition, following the start of charge accumulation in the R pixels, the N and S signals of those pixels are transferred, A/D converted, and stored in the N memory 502 and the S memory 503, respectively.

In addition, at time t902, delayed from time t901 by the phase difference T_g, charge accumulation in the Gr pixels and Gb pixels is started collectively. That is to say, charge accumulation in the Gr pixels and Gb pixels starts at a different timing from that in the R pixels. As with the R pixels, this charge accumulation is performed during the entire exposure time that is an image capturing parameter. Since the blinking cycle of LED_G occurs with a delay of the phase difference T_g relative to the blinking cycle of LED_R, by starting charge accumulation in the Gr pixels and Gb pixels at time t902, it is possible to synchronize with the timing when LED_G changes from the off state to the on state. In addition, following the start of charge accumulation in the Gr pixels and Gb pixels, the N and S signals of these pixels are transferred, A/D converted, and stored in the N memory 502 and the S memory 503, respectively.

In addition, at time t903, delayed from time t901 by the phase difference of T_b, charge accumulation in the B pixels is started collectively. That is, charge accumulation in the B pixels is started at a different timing from that in the R pixels and Gr and Gb pixels. This charge accumulation is performed during the entire exposure time that is the image capturing parameter, in a similar manner to the R pixels. Since the blinking cycle of LED_B occurs with a delay of the phase difference of T_b relative to the blinking cycle of LED_R, by charge accumulation starting in the B pixels at time t903, it is possible to synchronize with the timing when LED_B changes from the off state to the on state. In addition, following the start of charge accumulation in the B pixels, the N and S signals of these pixels are transferred, A/D converted, and stored in the N memory 502 and the S memory 503, respectively.

During the period from time t904 to t905, image capture signals obtained by CDS processing are read out from the memories of the pixels in pixel row order of the image sensor 2.

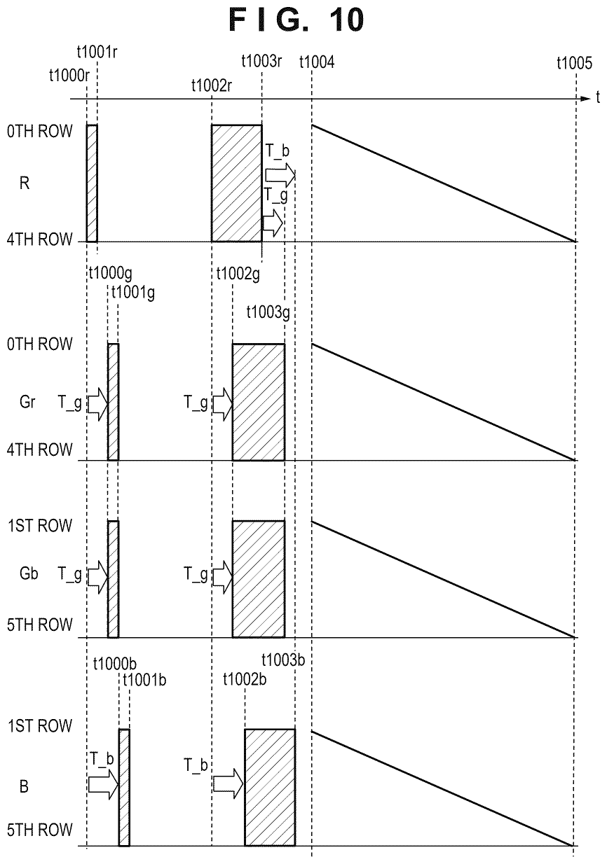

In one aspect, the operation control from t901 to t905 shown in FIG. 9 may be performed as in the timing chart shown in FIG. 10.

During the period from time t1000r to t1001r, which corresponds to the process of a reset operation, the reset operation of the PD 10 and FD node of each R pixels is performed, and charge accumulation is then started.

Similarly, during the period from time t1000g to t1001g, which starts with a delay of the phase difference T_g relative to time t1000r, the reset operation of the PDs 10 and FD nodes of the respective Gr and Gb pixels is performed, and charge accumulation is then started.

Similarly, during the period from time t1000b to t1001b, which starts with a delay of the phase difference T_b relative to time t1000r, the reset operation of the PD 10 and FD node of each B pixels is performed, and charge accumulation is then started.

The period from time t1001r to t1002r corresponds to the process of charge accumulation, and the PD 10 of each R pixel performs photoelectric conversion of incident light during the same period, and charge accumulation is performed.

Similarly, during the period from time t1001g to t1002g, which starts with a delay of the phase difference T_g relative to time t1001r, the PDs 10 of the Gr and Gb pixels perform photoelectric conversion of incident light during the same period, and charge accumulation is performed.

Similarly, during the period from time t1001b to t1002b, which starts with a delay of the phase difference T_b relative to time t1001r, the PD 10 of each B pixel performs photoelectric conversion of incident light during the same period, and charge accumulation is performed.

Next, the period from time t1002r to t1003r corresponds to the processes of charge transfer and A/D conversion, and a digital signal obtained by A/D converting the N signal generated when the reset of the FD node of each R pixel is released is stored in the N memory 502. Next, the charge accumulated in the PD 10 of each R pixel is transferred to the FD node of that pixel, and a digital signal obtained by A/D converting an S signal generated from the FD node where the charge is accumulated is stored in the S memory 503. As a result, digital signals related to the N and S signals are stored in the memories of all R pixels of the image sensor 2.

Similarly, during the period from time t1002g to t1003g, which starts with a delay of the phase difference T_g relative to time t1002r, digital signals obtained by A/D converting N signals generated when the reset of the FD nodes of the respective Gr and Gb pixels is released are stored in the N memories 502. Next, the charges accumulated in the PDs 10 of the respective Gr and Gb pixels are transferred to the FD nodes of those pixels, and digital signals obtained by A/D converting S signals generated from the FD nodes where the charges are accumulated are stored in the S memories 503. As a result, digital signals related to the N and S signals are stored in the memories of all Gr pixels and Gb pixels of the image sensor 2.

Similarly, during the period from time t1002b to t1003b, which starts with a delay of the phase difference T_b relative to time t1002r, a digital signal obtained by A/D converting an N signal generated when the reset of the FD node of each B pixel is released is stored in the N memory 502. Next, the charge accumulated in the PD 10 of each B pixel is transferred to the FD node of that pixel, and a digital signal obtained by A/D converting an S signal generated from the FD node where the charge is accumulated is stored in the S memory 503. As a result, digital signals related to the N and S signals are stored in the memories of all B pixels of the image sensor 2.

The period from time t1004 to t1005 corresponds to the digital signal readout process, and control similar to the operation control of the image sensor 2 during the period from time t604 to t605 when performing the global shutter operation shown in FIG. 6 is performed. That is to say, while sequentially switching the rows from the 0th row (where R pixels and Gr pixels are arranged) to the 5th row (where Gb pixels and B pixels are arranged) of the image sensor 2, the data transfer unit 40 reads out digital signals related to the N signals and S signals stored in the memories of the pixels of each row and transfers the digital signals to the image capture signal processing unit 50. The image capture signal processing unit 50 performs CDS processing on the transferred digital signals to derive image capture signals corresponding to a subject image formed in the pixels.

By adopting such a configuration, even though they are asynchronous, image capture signals are obtained when the PDs 10 are exposed for a common duration starting from the same phase of the blinking cycles of the LEDs of the respective colors. Therefore, a recorded image generated using these signals can be an image that shows similar color tone to that of a live view image, regardless of the timing of the operation input related to the image capturing instruction.

### Still Image Capturing Processing

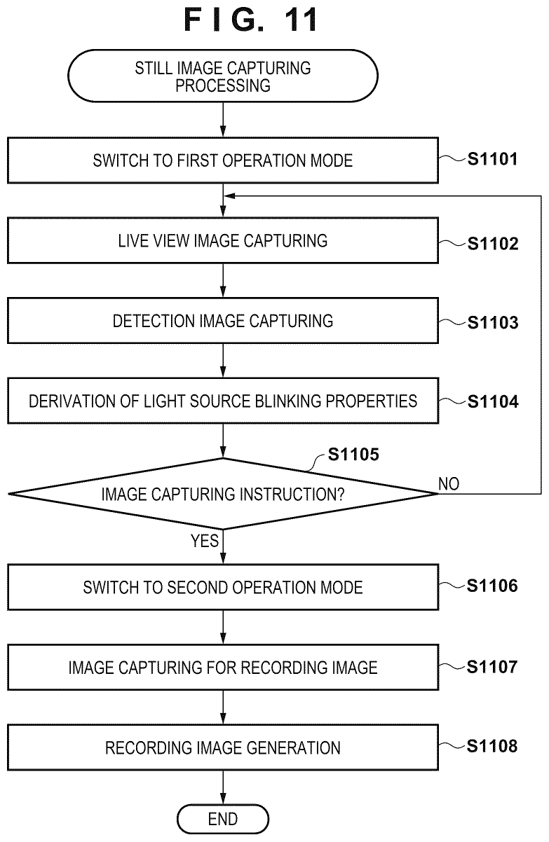

As one aspect, with respect to still image capturing processing that is executed during still image capturing by the image capture apparatus 100 according to the present embodiment, specific processing will be described with reference to the flowchart in FIG. 11. Processing corresponding to the flowchart can be realized, for example, by the synchronization control unit 6 reading a corresponding processing program stored in the ROM, deploying the program to the RAM, and executing the program.

In an aspect to be described below, still image capturing processing is started when operation input related to an image capturing preparation instruction is detected. In a state where the image capture apparatus 100 is set to the image capture mode and is activated, the image sensor 2 is controlled so as to capture a live view image once during each frame period to realize live view display at a predetermined frame rate (for example, 60 fps). Then, when operation input related to an image capturing preparation instruction is detected, the operation control of the image sensor 2 is switched to the first operation mode and is controlled so as to capture a live view image once and to capture a detection image N times, during each frame period. Thereafter, when operation input related to an image capturing instruction is detected, operation control of the image sensor 2 is switched to the second operation mode and control is performed so as to perform image capturing processing for recorded images (actual image capturing).

At S1101, the synchronization control unit 6 switches the operation control of the image sensor 2 to the first operation mode based on detected operation input related to an image capturing preparation instruction.

At S1102, the synchronization control unit 6 controls the operation of the image sensor 2 to capture a live view image. By performing this control, all of the pixels of the image sensor 2 are driven in the global shutter operation, and a live view image is generated. The generated live view image is transmitted to the image display unit 8 and displayed on the display device.

In S1103, the synchronization control unit 6 controls the operation of the image sensor 2 to capture a detection image. By performing this control, all of the pixels of the image sensor 2 are driven in the global shutter operation, and a detection image is generated. At this time, as the exposure time for the PDs 10 of all of the pixels, an exposure time that is an image capturing parameter set for actual image capturing is used. As described above, a detection image is captured a plurality of times (N times), but the number of times such image capturing is performed may be determined, for example, such that the image capturing is completed within one frame period based on the exposure time for actual image capturing.

In S1104, under the control of the synchronization control unit 6, the detection unit 4 derives blinking properties of the light sources of the respective colors (LED_R, LED_G, and LED_B) arranged in the image capturing environment based on a plurality of detection images obtained in S1103. Specifically, the signal processing unit 3 first derives computation results indicating variation of the image signals for the respective colors, for each of the plurality of detection images under the control of the synchronization control unit 6. The detection unit 4 derives the blinking cycles and phases as the blinking properties of the light sources of the respective colors based on the discrete computation results (computation results for a timing for capturing each detection image) derived by the signal processing unit 3. The detection unit 4 also derives the phase difference T_g between blinking of the light source of the G components and blinking of the light source of the R component and the phase difference T_b between blinking of the light source of the B components and blinking of the light source of the R component.

In S1105, the synchronization control unit 6 determines whether or not operation input related to an image capturing instruction has been detected. Upon determining that operation input related to an image capturing instruction has been detected, the synchronization control unit 6 advances the procedure to S1106. In addition, upon determining that operation input related to an image capturing instruction has not been detected, the synchronization control unit 6 returns the procedure to S1102. That is to say, during a period during which the operation input related to the image capturing preparation instruction continues, the synchronization control unit 6 repeats the processing of S1102 to S1105 for one frame period for live view display. Note that, when the continuation of the operation input related to the image capturing preparation instruction is released, the synchronization control unit 6 cancels the first operation mode for operation control of the image sensor 2 and completes the still image capturing processing.

In S1106, the synchronization control unit 6 switches operation control of the image sensor 2 to the second operation mode.

In S1107, the synchronization control unit 6 controls the operation of the image sensor 2 to capture a recorded image. In the second operation mode, as described above, the timing when exposure of the PDs 10 of the R pixels is started is used as a reference, exposure of the PDs 10 of the G pixels (Gr and Gb pixels) is started with a delay of the phase difference T_g, and exposure of the PDs 10 of the B pixels is started with a delay of the phase difference T_b.

In S1108, under the control of the synchronization control unit 6, the image recording unit 9 applies predetermined image processing to image capture signals obtained through image capturing to generate a recorded image, and records the recorded image in a recording device, thereby completing the still image capturing process.

As described above, the image capture apparatus according to the present embodiment can realize image capturing in which color tone variations caused by blinking of light sources are reduced.

### Second Embodiment

In the above embodiment, an aspect has been described in which, in the second operation mode, the process of charge accumulation and the process of charge transfer and A/D conversion are performed at different timings for the R pixels, G pixels (Gr and Gb pixels), and B pixels as shown in the timing chart in FIG. 10. That is to say, in the above embodiment, both of these processes are performed with the start timing shifted for each pixel color. On the other hand, in order to perform control in which the start timings of a plurality of image capturing processes differ, control lines are required to control the operations of elements constituting the image sensor 2, and the operation of the slope voltage generation circuit of RAMP 70 needs to be controlled for each color component. That is to say, there is the possibility that operation control of the image sensor 2 may be complicated.

In the present embodiment, a technique will be described that makes it possible to collectively perform, for all of the pixels, an A/D conversion operation that needs to be performed by causing the reference signal VRamp to be output from the RAMP 70, from among the process of charge transfer and A/D conversion. That is to say, the image sensor 2 according to the present embodiment performs operations of charge accumulation in the PDs 10 and charge transfer from the PDs 10 to FD nodes, independently for each color of the pixels, while control is performed such that the A/D conversion operation is performed collectively for all of the pixels. Hereinafter, a mode in which operation control of the image sensor 2 is performed in this manner will be referred to as a “third operation mode” that is different from the second operation mode.

### A/D Conversion of Image Signals

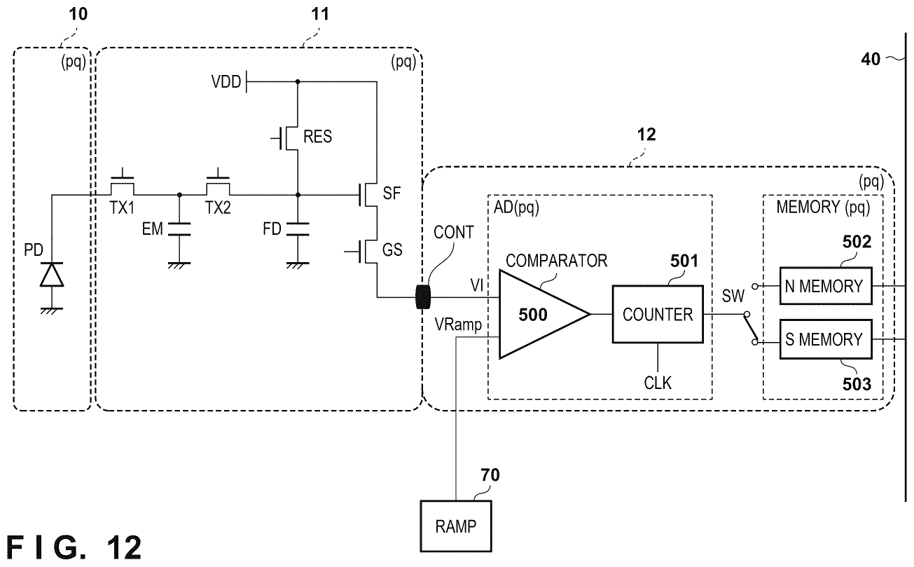

A flow of A/D conversion of image signals related to image capturing using the image sensor 2 according to the present embodiment will be described with reference to the equivalent circuit diagram of the PD 10 (pq), the pixel circuit 11 (pq), and the stacked circuit 12 (pq) involved in the A/D conversion in FIG. 12. The equivalent circuit diagram shown in FIG. 12 differs from the equivalent circuit diagram according to the first embodiment shown in FIG. 5 in that a charge holding node EM and two transfer transistors TX1 and TX2 are provided between the PD 10 (pq) and the FD node.

### Third Operation Mode

In the third operation mode, charge accumulation in the PD 10 (pq) of a pixel of each color starts at an independent timing, and the accumulated charges are then transferred to EM via TX1 similarly at timing for each color. That is, the processes of charge accumulation and charge transfer are controlled independently for the pixels of each color. On the other hand, digital signals obtained by A/D converting N signals that are input from the FD nodes to the comparator 500 when reset is released and digital signals obtained by A/D converting S signals that are input to the comparator 500 for the charges transferred from EM to the FD nodes can be stored collectively for all of the pixels. That is to say, control is performed such that the process of A/D conversion is collectively performed for all of the pixels, similarly to that in the first operation mode.

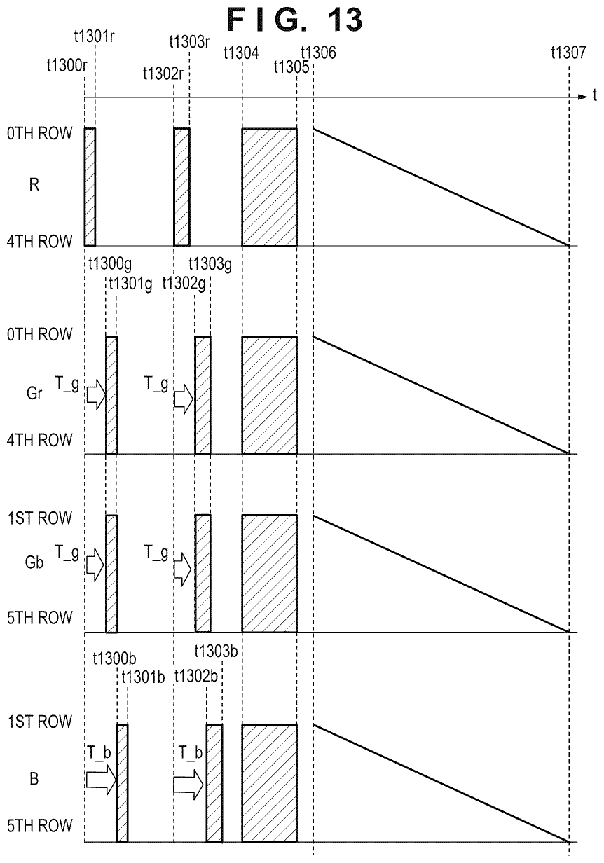

This control can be performed generally as shown in the timing chart in FIG. 13.

During the period from time t1300r to t1301r, which corresponds to the process of a reset operation, the reset operation of the PD 10 and FD node of each R pixel is performed, and charge accumulation is then started.

Similarly, during the period from time t1300g to t1301g, which starts with a delay of the phase difference T_g relative to time t1300r, the reset operation of the PDs 10 and FD nodes of the respective Gr and Gb pixels is performed, and charge accumulation is then started.

Similarly, during the period from time t1300b to t1301b, which starts with a delay of the phase difference T_b relative to time t1300r, the reset operation of the PD 10 and FD node of each B pixel is performed, and charge accumulation is then started.

During the period from time t1301r to t1302r, which corresponds to the process of charge accumulation, the PD 10 of each R pixel performs photoelectric conversion of incident light during the same period, and charges are accumulated.

Similarly, during the period from time t1301g to t1302g, which starts with a delay of the phase difference T_g relative to time t1301r, the PDs 10 of the Gr and Gb pixels perform photoelectric conversion of incident light during the same period, and charges are accumulated.

Similarly, during the period from time t1301b to t1302b, which starts with a delay of the phase difference T_b relative to time t1301r, the PD 10 of each B pixel performs photoelectric conversion of incident light during the same period, and charges are accumulated.

Next, the period from time t1302r to t1303r corresponds to the process of charge transfer, and in response to the release of the reset of the FD node of each R pixel, the charge accumulated in the PD 10 of each R pixel is transferred to the EM of that pixel. As a result, the charges generated in all R pixels of the image sensor 2 by exposure are temporarily held in the EMs.

Similarly, during the period from time t1302g to t1303g, which starts with a delay of the phase difference T_g relative to time t1302r, in response to the release of the reset of the FD nodes of the respective Gr and Gb pixels, the charges accumulated in the PDs 10 of the Gr and Gb pixels are transferred to the EMs. As a result, the charges generated in all Gr and Gb pixels of the image sensor 2 by exposure are temporarily held in the EMs.

Similarly, during the period from time t1302b to t1303b, which starts with a delay of the phase difference T_b relative to time t1302r, in response to the release of the reset of the FD node of each B pixel, the charge accumulated in the PD 10 of each B pixel is transferred to the EM of that pixel. As a result, the charges generated in all B pixels of the image sensor 2 by exposure are temporarily held in the EMs.

During the period from time t1304 to t1305, which corresponds to the process of A/D conversion, digital signals obtained by A/D converting N signals generated when the reset of the FD nodes of all pixels is released are stored in the N memories 502. Next, the charges accumulated in the EMs of all pixels are transferred to the FD nodes of those pixels, and digital signals obtained by A/D converting S signals generated from the FD nodes where charges are accumulated are stored in the S memories 503. As a result, digital signals related to the N and S signals are stored in the memories for all pixels of the image sensor 2.

During the period from time t1306 to t1307, which corresponds to the process of digital signal readout, control similar to that performed during the period from time t604 to t605 of the operation control of the image sensor 2 when performing the global shutter operation shown in FIG. 6 is performed. That is to say, while sequentially switching the rows from the 0th row (where R pixels and Gr pixels are arranged) to the 5th row (where Gb pixels and B pixels are arranged) of the image sensor 2, the data transfer unit 40 reads out digital signals related to the N and S signals stored in the memories of the pixels of each row and transfers the digital signals to the image capture signal processing unit 50. The image capture signal processing unit 50 performs CDS processing on the transferred digital signals to derive image capture signals corresponding to a subject image formed in those pixels.

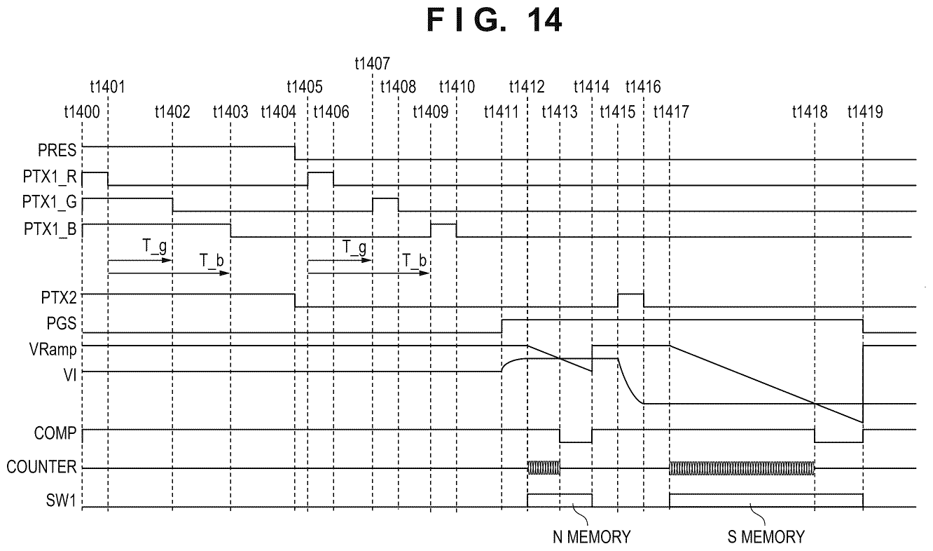

FIG. 14 shows a timing chart of the drive control of the equivalent circuit (FIG. 12) of one pixel in the third operation mode. In the figure, PTX1_R, PTX1_G, and PTX1_B respectively denote control signals supplied to TX1 of the R pixel, Gr and Gb pixels, and the B pixel, and each indicates the polarity of a voltage applied to the gate of the transistor. In addition, PTX2 is a control signal supplied to TX2 of all of the pixels, and indicates the polarity of a voltage applied to the gate of TX2 similarly. These control signals may be generated by the timing generation circuit 80, similarly to other control signals.

At time t1400, in response to PRES, PTX1_R, PTX1_G, PTX1_B, and PTX2 being set to Hi, the PD 10, the EM, and the FD node are reset.

At time t1401, in response to PTX1_R being changed to Lo, the reset state of the PD 10 of the R pixel is released, and charge accumulation in the PD 10 is started.

In addition, at time t1402 which starts with a delay of the phase difference of T_g relative to time t1401, in response to PTX1_G being changed to Lo, the reset state of the PDs 10 of the Gr and Gb pixels is released, and charge accumulation in the PDs 10 is started.

Furthermore, at time t1403 which starts with a delay of the phase difference T_b relative to time t1401, in response to PTX1_B being changed to Lo, the reset state of the PD 10 of the B pixel is released and charge accumulation in the PD 10 is started.

At time t1404, in response to PRES and PTX2 being changed to Lo, the reset state of the FD nodes of all of the pixels is collectively released.

Next, during the period from time t1405 to t1406, in response to PTX1_R being set to Hi, the charge accumulated in the PD 10 of the R pixel is transferred to the EM.

In addition, during the period from time t1407 to t1408 which starts with a delay of the phase difference T_g relative to time t1405, in response to PTX1_G being set to Hi, the charges accumulated in the PDs 10 of the Gr and Gb pixels are transferred to the EMs.

Furthermore, during the period from time t1409 to t1410 which starts with a delay of the phase difference T_b relative to time t1405, in response to PTX1_B being set to Hi, the charge accumulated in the PD 10 of the B pixel is transferred to the EM.

Thereafter, at time t1411, in response to PGS being changed to Hi, the voltage signal VI of the reset level of the FD node, namely, the N signal is input to the comparator 500 via the contact CONT.

The operation during the period from time t1412 to t1414 is similar to the operation during the period from time t704 to t706 in the first operation mode, and a digital signal related to an N signal is stored in the N memory 502.

At time t1415, in response to PTX2 being changed to Hi, the charge accumulated in the EM starts to be transferred to the FD node, and the charge is accumulated in the FD node. Thereafter, at time t1416, in response to PTX2 being changed to Lo, the voltage signal VI corresponding to the amount of charge accumulated in the FD node, that is, the S signal is input to the comparator 500 via the contact CONT.

The operation during the period from time t1417 to t1419 is similar to the operation during the period from time t709 to t711 in the first operation mode, and a digital signal related to an S signal is stored in the S memory 503.

As described above, in the image sensor 2 according to the present embodiment, in the third operation mode, it is sufficient that operation control of only the PD 10 and TX1 is performed for the pixels of each color, and control is then performed in a similar manner to the global shutter operation in the first operation mode, and thus the operation control can be more simplified than in the second operation mode.

Note that, in the present embodiment, a description has been given in which charge transfer from the PD 10 to EM is performed at different timing for the pixels of each color, but implementation of the embodiment of the present technique is not limited to this. It goes without saying that control may be performed such that charge transfer to EM is also performed collectively for all of the pixels, similar to A/D conversion. That is to say, it suffices for the present technique to be a technique for controlling the exposure timing for capturing detection images in the third operation mode (or the second operation mode) based on the difference (phase difference) in blinking properties of the LEDs of the respective colors, obtained in the first operation mode.

In addition, in the present embodiment, a description has been given in which the pixel circuit 11 is provided with a charge holding node (EM), but implementation of the present technique is not limited thereto. The charge holding node may be provided, for example, upstream of the A/D conversion circuit of the stacked circuit 12.

### Variation 1

In the above embodiments, an example has been described in which discrete Fourier transform is used to derive blinking properties of the LED of each color, but implementation of the present technique is not limited thereto. For example, when an accumulation period for a live view image is 8.0 ms (Tv: 1/125) and an accumulation period for a detection image is 0.25 ms (Tv: 1/4000), the accumulation period ratio is 8.0/0.25=32. At this time, the level of an image signal obtained from a detection image is thought to be preferably about 1/32 of the level of an image signal obtained from a live view image. Therefore, the image signals in detection images for each color may be compared based on computation results of the image signals in the live view image for the color, to derive a phase difference for the color from a frame that shows a value close to 32.

### Variation 2

In the above embodiments, a description has been given in which, based on the assumption that the phases of the blinking cycles of the LEDs of the respective colors are not synchronized with each other at the timing when a detection image is captured, blinking properties are derived based on detection images obtained through image capturing performed a plurality of times. On the other hand, depending on the timing and frequency at which detection images are captured, the phases of blinking of the LED_R, LED_G, and LED_B may be synchronized at the timing of capturing a detection image, and signal levels related to blinking of the LED of the respective colors sampled from the detection images may be identical every time. As a result, even if a plurality of detection images are obtained, the blinking properties of the LEDs of the respective colors cannot be derived based on these detection images.

For this reason, for example, a configuration may be adopted in which the timing at which detection images are captured differs for each frame over a plurality of frame periods of live view display, thereby obtaining a greater number of detection images in which the phases of blinking differ. That is, this control makes it possible to increase the number of detection images used for deriving the blinking properties, and to improve the detection accuracy.

### Variation 3

In the above embodiments, a description has been given on the assumption that the exposure time of detection images is sufficiently short relative to the blinking cycles of the LEDs, and that charge accumulation, A/D conversion, and signal readout can be performed N times within one frame period, excluding the exposure period for one live view image. However, depending on the exposure time of detection images, it may not be possible to ensure a sufficient signal readout period for obtaining the number of detection images necessary for deriving the blinking properties of the LEDs of the respective colors. For this reason, in the process of reading out digital signal obtained by performing A/D conversion related to detection images, control may be performed so as to shorten the time required for signal readout by performing, for example, averaging addition or thinning processing.

### Variation 4

In the above embodiments, a description has been given in which the phase differences related to blinking of LED_G and LED_B are derived as the phase differences relative to blinking of LED_R, in order to control the exposure timings of the Gr pixels, Gb pixels, and B pixels based on the timing at which exposure of the R pixels is started. However, the implementation of the present technique is not limited thereto, and a phase difference used to control the exposure timing for the LED of one color may be derived as a phase difference relative to the LED of another color.

### Variation 5

Incidentally, a description has been given in which, in the above second and third operation modes, digital signals obtained through exposure performed at different timings for the respective colors are obtained and are used to generate one recorded image. That is, the R pixels, G pixels (Gr and Gb pixels), and B pixels, which are used for generating a recorded image, are image signals obtained through asynchronous exposure, and thus represent an image of the subject corresponding to strictly different clock times. Accordingly, when, for example, the phase differences T_g and T_b are larger than the exposure time set as an image capturing parameter, subject blur may occur in a generated recorded image. For this reason, when the derived phase differences are larger than the exposure time setting value, control may be performed such that a phase difference is derived relative to the phase of the blinking of LED_G, which is required in general development processing, and exposure for capturing a recorded image is started from the Gr pixels and the Gb pixels.

### Variation 6

In the above embodiments and variations, a description has been given in which light sources that exhibit blinking different between colors are the R, G, and B color LEDs, but implementation of the present technique is not limited thereto. The present technique is applicable to control of any image sensor 2 that is used in an image capturing environment in which light sources of multiple colors that exhibit respectively different blinking are arranged.

With the above configuration, according to the present technique, it is possible to realize image capturing in which color tone variations caused by blinking of the light sources are reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, and a memory card.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-020988, filed Feb. 12, 2025, which is hereby incorporated by reference herein in its entirety.

What is claimed is:

1. A control device for controlling an operation of an image sensor, comprising:
a control unit for controlling charge accumulation in a plurality of photoelectric conversion elements of the image sensor that captures an image of a subject illuminated by light sources of a plurality of colors, each light source blinking at a respective blinking frequency; and
a detection unit for detecting properties of the light sources of the respective colors based on image signals output from the image sensor,
wherein the detection unit is configured to:
obtain a first image captured during a first period that is longer than or equal to one cycle of blinking of the subject and a second image group of a plurality of second images captured during a second period that is shorter than the first period;
detect color tone of the subject blinking due to the light sources of the plurality of colors, using the first image; and
detect blinking properties of the light sources of the respective colors using the second image group, and
the control unit is configured to cause the photoelectric conversion elements of the image sensor that correspond to different colors to start charge accumulation at different timings based on the detected color tone and the detected blinking properties of the light sources of the respective colors.

2. The control device according to claim 1,
wherein the control unit is configured to cause the photoelectric conversion elements of the image sensor that correspond to the plurality of colors to perform charge accumulation a plurality of times during a common exposure period to obtain the second image group.

3. The control device according to claim 2,
wherein the detection unit is configured to detect the blinking properties of the light sources of the respective colors based on information regarding variations in blinking states of light of the respective colors in the second image group.

4. The control device according to claim 1,
wherein the blinking properties include cycles and phases of blinking of the light sources.

5. The control device according to claim 4,
wherein the control unit is configured to set a timing at which, among the photoelectric conversion elements of the image sensor that correspond to the plurality of colors, a first photoelectric conversion element corresponding to a first color from among the plurality of colors starts charge accumulation, and a timing at which a second photoelectric conversion element corresponding to a second color from among the plurality of colors starts charge accumulation, with a shift corresponding to a phase difference between blinking of light of the first color and blinking of light of the second color.

6. The control device according to claim 5,
wherein the image sensor is configured by applying a Bayer array filter to the plurality of photoelectric conversion elements that are two-dimensionally arranged, and
the plurality of colors include an R color, a G color, and a B color.

7. The control device according to claim 6,
wherein the first color is the G color, and the second color is the R color or the B color, and
the control unit is configured to cause the second photoelectric conversion element to start charge accumulation at a timing delayed relative to the timing for starting charge accumulation in the first photoelectric conversion element, by an amount corresponding to the phase difference between blinking of light of the first color and blinking of light of the second color.

8. The control device according to claim 1,
wherein the image sensor includes transfer unit for transferring charges accumulated in the plurality of photoelectric conversion elements, and
the control unit is further configured to cause, based on the information regarding the blinking properties of the light sources of the respective colors, the transfer unit to transfer charges accumulated in, from among the photoelectric conversion elements of the image sensor that correspond to the plurality of colors, a first photoelectric conversion element corresponding to a first color from among the plurality of colors, and charges accumulated in a second photoelectric conversion element corresponding to a second color from among the plurality of colors, at different timings.

9. The control device according to claim 1,
wherein the image sensor includes A/D conversion unit for converting charges accumulated in the plurality of photoelectric conversion elements into digital signals corresponding to charge amounts,
the control unit is further configured to control the A/D conversion unit of the image sensor, and
in a case of performing charge accumulation in the plurality of photoelectric conversion elements during a common exposure period, the control unit is configured to cause the A/D conversion unit to collectively convert charges accumulated in, from among the photoelectric conversion elements of the image sensor that correspond to the plurality of colors, a first photoelectric conversion element corresponding to a first color from among the plurality of colors, and charges accumulated in a second photoelectric conversion element corresponding to a second color from among the plurality of colors, into digital signals.

10. The control device according to claim 9, further comprising
input unit for detecting operation input,
wherein, when predetermined operation input is detected, the control unit is configured to switch operation control of the image sensor from a first operation mode in which charge accumulation is performed in the plurality of photoelectric conversion elements during the common exposure period, to a second operation mode in which charge accumulation is performed in the plurality of photoelectric conversion elements based on information regarding the blinking properties of the light sources of the respective colors.

11. The control device according to claim 10,
wherein, in the second operation mode, the control unit is configured to cause the A/D conversion unit to perform conversion into a digital signal corresponding to the first photoelectric conversion element and conversion into a digital signal corresponding to the second photoelectric conversion element, at different timings.

12. The control device according to claim 10,
wherein the image sensor further includes charge holding units configured to temporarily hold charges accumulated in the plurality of photoelectric conversion elements, and
in the second operation mode, the control unit is configured to cause the A/D conversion unit to collectively convert a charge amount corresponding to the first photoelectric conversion element held by the charge holding unit and a charge amount corresponding to the second photoelectric conversion element held by the charge holding unit, into digital signals.

13. The control device according to claim 10,
wherein the predetermined operation input is operation input related to an image capturing instruction.

14. The control device according to claim 13,
wherein, when operation input related to an image capturing preparation instruction is detected, the control unit is configured to switch operation control of the image sensor to the first operation mode.

15. The control device according to claim 13,
wherein, in the second operation mode, the control unit is configured to cause the first and second photoelectric conversion elements to perform charge accumulation during an exposure time set as an image capturing parameter.

16. The control device according to claim 15,
wherein a length of the common exposure period is same as the exposure time set as an image capturing parameter.

17. The control device according to claim 1,
wherein the second period is shorter than one cycle of blinking of the light source of each of the colors.

18. An image capture apparatus comprising:
the control device according to claim 1, and
the image sensor.

19. A control method of a control device that controls an operation of an image sensor, comprising:
controlling charge accumulation in a plurality of photoelectric conversion elements of the image sensor that captures an image of a subject illuminated by light sources of a plurality of colors, each light source blinking at a respective blinking frequency; and
detecting properties of the light sources of the respective colors based on image signals output from the image sensor;
in the detecting:
a first image captured during a first period that is longer than or equal to one cycle of blinking of the subject and a second image group of a plurality of second images captured during a second period that is shorter than the first period are obtained;
color tone of the subject blinking due to the light sources of the plurality of colors is detected using the first image; and
blinking properties of the light sources of the respective colors are detected using the second image group, and
in the controlling, charge accumulation is started in the photoelectric conversion elements of the image sensor that correspond to different colors at different timings based on the detected color tone and the detected blinking properties of the light sources of the respective colors.

20. A computer-readable storage medium storing the program according to claim 19.
